(19) United States
(12) Patent Application Publication
(10) Pub. No.: US 2022/0111460 A1
(43) Pub. Date: Apr. 14, 2022

(54) A METHOD FOR AUTOMATIC WELDING OF A STRUCTURAL STEEL ASSEMBLY AND AN AUTOMATIC WELDING SYSTEM FOR WELDING OF A STRUCTURAL STEEL ASSEMBLY

(71) Applicant: VOORTMAN STEEL MACHINERY HOLDING B.V., Rijssen (NL)

(72) Inventors: Arie RIEZEBOS, Boekelo (NL); Peter LANTING, Hengelo (NL)

(73) Assignee: VOORTMAN STEEL MACHINERY HOLDING B.V., Rijssen (NL)

(21) Appl. No.: 17/431,858

(22) PCT Filed: Apr. 6, 2020
(86) PCT No.: PCT/NL2020/050231

§ 371 Date: Aug. 18, 2021

(30) Foreign Application Priority Data
Apr. 5, 2019 (NL) 2022872

(51) Int. Cl. B23K 9/095; B23K 26/08; B23K 11/25; B23K 11/16; B23K 26/00; B23K 9/23

(52) U.S. Cl. CPC B23K 9/0953; B23K 26/0884; B23K 11/252; B23K 2103/04; B23K 26/0006; B23K 9/23; B23K 11/16

(57) ABSTRACT

A method for automatic welding of a structural steel assembly includes workpieces such as profiles and/or a sheet material. The method includs using an automated process to receive information from a CAD-CAM program about welds for welding the structural steel assembly, and to post-process the information received from the CAD-CAM program. The information of each single weld received from the CAD-CAM program includes data about e.g a type of a workpiece or of workpieces of the structural steel assembly which bound the weld, a weld type, a position of the respective weld relative to the workpieces of the structural steel assembly that bound the weld, a shape of the weld, a length of the weld, a path of the weld and a width of the weld. The post-processing includes splitting each weld in sections of which the individual welding parameters are predefined.

### FIELD

The invention relates to a method for automatic welding of a structural steel assembly comprising a profile and/or a sheet material, and an automatic welding system for welding of a structural steel assembly comprising a profile and/or a sheet material.

### BACKGROUND

Known automatic welding systems for welding of a structural steel assembly comprising a profile and/or a sheet material, usually comprise one or more robot arms which weld the structural parts together to form the desired assembly. It is customary to use CAD-CAM software to design the assembly. The CAD-CAM software then provides information about the structure of the assembly to such a welding system.

Sometimes the CAD-CAM software is also able to identify the junctions between the assembled parts which need to be welded, to determine the welds for welding these junctions, and to generate information about these welds. Such information may comprise e.g. a position relative to the structural steel assembly, a shape of the weld, a length of the weld, a width of the weld, and a weld type. Examples of weld types are fillet weld, edge weld, spot weld, etc.

The information of the welds can be transferred to the automatic welding system together with the information about the structure of the structural steel assembly. Known automatic welding systems are able to read such a CAD-CAM-file with information for each weld. These automatic welding systems then need to be programmed to perform the desired welding operations. Known systems can do this automatically. The welding system then determines how to move the welding robot arm in order to weld the received weld. Such a system is described in JPH082867522A.

For the welding itself, different welding parameters can be chosen. Examples of such welding parameters are an amperage and a voltage of a used electrode, a speed of movement of the robot arm, a frequency of weaving, a horizontal distance, a vertical distance of a used weaving pattern, and a pulse frequency of the welding source. These welding parameters are selected by the operator based on information of the structural assembly to be welded. The operator may take various factors into consideration, e.g. the thickness of the parts to be welded, the width of a possible gap between the parts, and the length of the weld. Based on this information the welding parameters are chosen in advance, that is prior to the welding. The selection of the welding parameters typically requires human input, in general from the operator.

Inputting information by an operator about welding parameters is known from JPH11-296215A. See in this respect FIG. 5 of this publications in which steps 1. A and B, 2. C and the first two lines of 3. are performed by the operator who is operating the robot controller. Subsequently, the operator may be assisted by a computer to prepare the welding route and settings.

JP2005316906 discloses a method in which intervention by a operator is needed as well. See in this respect for example [0012] in which work data input unit 20 is a terminal in which the shape, material, plate thickness, and the like of the workpiece are input by an operator. Also the order of welding is inputted by an operator. See in this respect [0013]. At best, JP2005316906 discloses a method for programming a number of welding robots in which the operator who programs the welding robots is assisted by a computer to divide the welding work over the various welding robots and to determine the shortest processing time, to subsequently determine torch angles, process conditions and interference between the different welding robots which operate simultaneously to perform the welding job.

CN109128439 discloses to use CAD-data to create a program in machine control language for controlling the movement of a welding robot. A vision system may be used to compare the CAD-information with the real object and to automatically and to self-correct the program so as to re-plan the welding robot's trajectory. As the first “beneficial effect” of the teaching of CN′439 is mentioned that the welding of each weld are constant.

### SUMMARY OF THE INVENTION

Selecting the correct welding parameters requires knowledge, skill and experience. Along the length of a weld, the welding parameters which are optimal may vary and sometimes some local characteristics of the weld area may be conflicting in that, e.g. for some aspects a high amperage and/or high voltage is desired (e.g. a large gap width) whereas for other aspects a lower welding temperature would be optimal (e.g. the thickness of the parts to be welded). A skilled welder is able to select the correct parameters and may even decide to vary the welding parameters along the length of a weld to obtain an optimal welding result.

It is an object of the invention to further provide a method for automatic welding of a structural steel assembly which takes into account local dimensions and conditions along the length of a weld and determines optimal welding parameters which may vary along the length of an individual weld.

To that end the invention provides a method in accordance with claim 1 for automatic welding of a structural steel assembly comprising workpieces such as profiles and/or a sheet material.

More particular, the method according to the invention comprises using an automated process to receive information from a CAD-CAM program about welds for welding the structural steel assembly, wherein the information of each single weld comprises weld data about at least one of:
a type of a workpiece or of workpieces of the structural steel assembly which bound the weld;
a weld type;
a position of the respective weld relative to the workpiece or workpieces of the structural steel assembly that bound the weld;
a shape of the weld;
a length of the weld;
a path of the weld and
a width of the weld.
   The automated process is also used to post-process the weld data of each weld, wherein the post-processing comprises splitting each weld in sections of which the individual welding parameters are predefined. The automated process is also used to create the weld thereby applying varying welding parameters along the length of the weld in accordance with the sections into which the weld has been split and the predefined welding parameters associated with these sections.

The method of the present invention splits the one weld in different sections. Due to the varying circumstances along the length of each weld, it is less optimal to keep the welding parameters the same for the entire weld. If the welding parameters were kept the same for the entire weld, the welding parameters would less well suited for certain parts of the weld. By the automated splitting of the weld in different sections, individual welding parameters can be set for each section of the weld. As a consequence, the welding parameters of each section are optimized for the local welding area conditions at that section. This will result in an overall better optimizing of the welding parameters and a weld of better quality.

JPH11-296215A does not disclose the automatic evaluation of CAD/CAM-data and the automatic post-processing of this data to create a welding program which splits a weld path in weld sections and provides varying welding conditions along the length of a weld without intervention of an operator. To the contrary, JPH11-296215A discloses several steps which have to be taken by an operator as elucidated in background section above.

JP2005316906 does not disclose automatically splitting a single welding path in sections of which the individual welding parameters are predefined so as to be able to vary welding parameters along the length of a single weld path.

The invention further provides an automatic welding system for welding of a structural steel assembly comprising a profile and/or a sheet material according to claim 12.

More particular, the automatic welding system comprises a welding robot, and a controller assembly which, in operation, operates the welding robot. The controller assembly is provided with a post-processing module configured to receive information from a CAD-CAM program about welds for welding the structural steel assembly. The information of each single weld comprises data about at least one of:
a type of a workpiece or of workpieces of the structural steel assembly which bound the weld;
a weld type;
a position of the respective weld relative to the workpiece or workpieces of the structural steel assembly that bound the weld;
a shape of the weld;
a length of the weld;
a path of the weld; and
a width of the weld; and

Additionally, the post-processing module is configured to post-process the information received from the CAD-CAM program. The post-processing comprises splitting each weld in sections of which the individual welding parameters are predefined. The automatic welding system is configured to create the weld thereby applying varying welding parameters along the length of the weld in accordance with the sections into which the weld has been split and the predefined welding parameters associated with these sections. It should be noted that the controller assembly may comprise various controller components. For example, a first component of the controller assembly may control the various drives of the welding robot, whereas a second component of the controller assembly may comprise the post-processing module configured to receive information from a CAD-CAM program about welds and to split each weld in sections of which the individual welding parameters are predefined. This second component may be, for example, an industrial PC, whereas the first component may be a dedicated electronic controller of the welding robot itself. The first and the second components of the controller assembly may be separate parts between which data may be exchanged. Alternatively, the first and second components may be part of a single integral electronic controller assembly.

The effects and advantages of the automatic welding system according to the invention are the same as the effects and advantages of the method according to the invention.

The profiles in this disclosure are not limited to well known H-profiles. In fact any type of profile may be used, e.g. a square tubing, a round tubing, a channel iron, or an angle iron. Any of these, or other known profiles, alone or in combination with any other profile or sheet material, may be used as the workpiece or workpieces in the method and in the automatic welding system according to the invention.

The present invention will be further elucidated with reference to figures of exemplary embodiments. The embodiments may be combined or may be applied separately from each other.

### BRIEF DESCRIPTION OF THE FIGURES

FIG. 1 shows a structural steel assembly comprising two sheet materials, with a provided weld for welding said sheet materials.

FIG. 2 shows the structural steel assembly of FIG. 1, wherein the weld is split in sections.

### DETAILED DESCRIPTION OF THE FIGURES

In this application similar or corresponding features are denoted by similar or corresponding reference signs. The description of the various embodiments is not limited to the examples shown in the figures and the reference numbers used in the detailed description and the claims are not intended to limit the description of the embodiments, but are included to elucidate the embodiments by referring to the examples shown in the figures.

In the most general terms, the invention relates to a method for automatic welding of a structural steel assembly 10 comprising workpieces such as profiles and/or a sheet material 12 which have to be connected by means of one or more welds 16. The method comprises using an automated process to receive information from a CAD-CAM program about welds 16 for welding the structural steel assembly 10. The information of each single weld 16 comprises weld data about at least one of:
a type of a workpiece or of workpieces of the structural steel assembly which bound the weld 16;
a weld type;
a position of the respective weld 16 relative to the workpiece or workpieces of the structural steel assembly 10 that bound the weld 16;
a shape of the weld 16;
a length 20 of the weld 16;
a path of the weld 16 and
a width of the weld 16.
   The automated process is additionally used to post-process the weld data of each weld. The post-processing comprises splitting each weld 16 in sections 18 of which the individual welding parameters are predefined. Finally, the method comprises creating the weld 16 thereby applying varying welding parameters along the length of the weld 16 in accordance with the sections 18 into which the weld 16 has been split and the predefined welding parameters associated with these sections 18.

The effects and advantages of the method have been described in the summary section and these effects and advantages are inserted here by reference.

Information of the weld 16 may also include the instruction to use a multilayer weld. A multilayer weld may, for example, be used when a relatively big gap should be bridged, or when the connection should be extra strong, or when one of the parts is relatively thick with respect to the part it should be welded to.

One of the sections 18 created during the post-processing may be a weld layer, e.g. a ground layer, an intermediate layer or a cover layer of a multilayer weld 16. By making a layer of a multilayer weld a different section, such a layer can have its own setting of welding parameters. The first layer of a multilayer weld, usually called a ground layer, can e.g. be made with a low voltage just to make sure the ground layer is made without damaging the workpieces bounding the weld to be formed. Subsequent layers, such as intermediate layers and a cover layer may be made thicker thereby applying a higher voltage/amperage.

The post-processing may further comprise extending the path of the weld 16 at at least one end thereof. One of the sections 18 created during the post-processing is a start section or a finish section corresponding to an extended part of the path of the weld 16. By extending the weld 16 received from the CAD-CAM program, the creating of the weld 16 can have a run-up or run-off to the creating of the original weld 16 received from the CAD-CAM program. The run-up may be used to ensure that all the correct welding parameters are used when creating a subsequent, neighboring section. The run-off may be used to weld 16 the section twice in order to ensure a secure ending of the weld 16.

In an embodiment the splitting each weld 16 in sections is preformed in dependence of specific characteristics chosen from the group comprising:
a configuration of the structural steel assembly 10 at various locations along the length of the weld 16, in particular the type of the workpieces which bound the respective weld, e.g. the type of profile, the type of sheet material, a gap between the workpieces at various locations along the length of weld 16;
the weld type;
the shape of the weld 16;
the length 20 of the weld 16;
the width of the weld 16; and
the location of a part of the weld relative to the entire weld, i.e. a start part of the weld, a middle part of the weld, a finish part of the weld; and
the local path of the weld at a part of the weld that is being considered to become a section, e.g. a straight path, an angled path, an arcuate path.

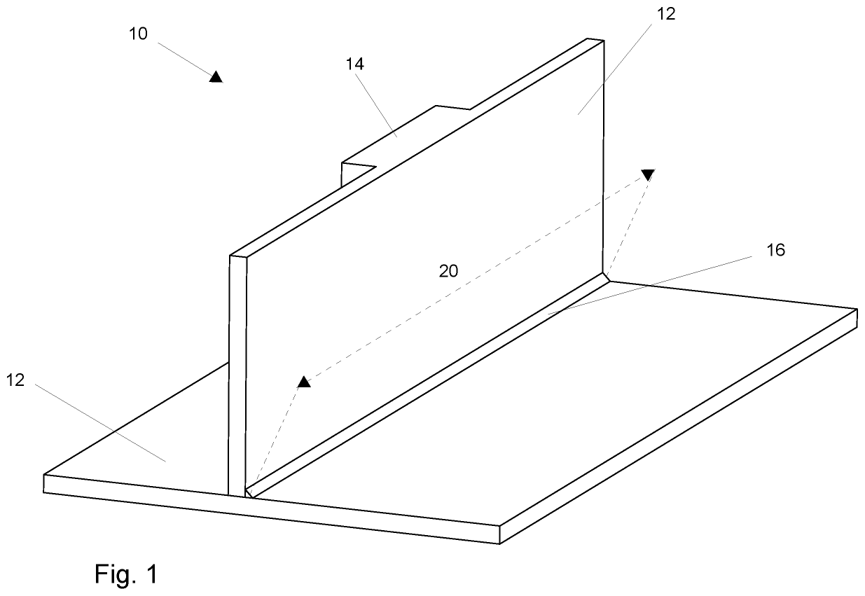

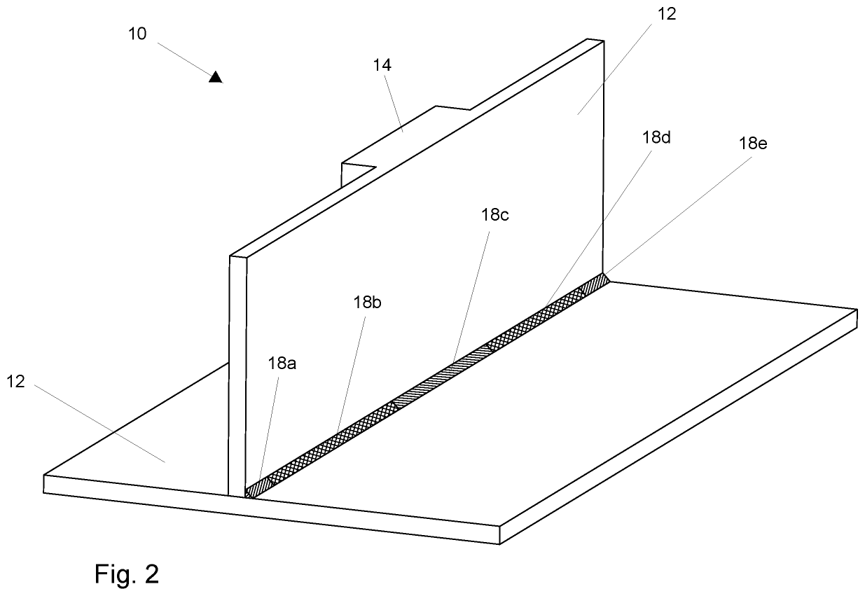

All described specific characteristics are part of the desired weld 16. A weld 16 can extend along different connection configurations. In the example shown in FIG. 1 the weld 16 extends along a junction near the edge of two sheets 12, along a junction between two sheets 12 of the same thickness, and along a junction between two sheets wherein one of the sheets 12 is much thinker at 14 than the other. These identified, different parts of the weld 16 may be used to split the weld 16 in sections 18, in particular sections 18a, 18b, 18c, 18d, 18e. This can be seen in the example of FIG. 2 wherein the previously mentioned parts of the weld 16 have led to the sections 18a-18e. Of course, other specific characteristics can also be used to split up the weld 16 in sections 18. Examples of weld types are fillet weld, edge weld, spot weld, etc.

In an embodiment the method further comprises defining and storing a number of predefined sections with predetermined welding parameters. Each predefined section is associated with specific characteristics chosen from the group comprising:
a configuration of the structural steel assembly 10 bounding the section, in particular the type of the workpieces which bound the respective section, e.g. the type of profile, the type of sheet material, a gap between the workpieces;
the weld type of the section;
the shape of the weld 16 of the section;
the length 20 of the weld 16 of the section; and
the width of the weld 16 of the section;
the location of the section relative to the entire weld, i.e. start section of the weld, middle section of the weld, finish section of the weld;
the local path of the section, e.g. a straight path, an angled path, an arcuate path; and
a layer position of the section within a multilayer weld, i.e. the section being a ground layer, an intermediate layer or a top layer of the multilayer weld.
   The method of this embodiment further comprises:
to compare, during the post-processing, the weld data of parts of the weld 16 with the predefined weld data of the number of predefined sections,
to identify parts of the weld 16 which have weld data which are similar to the predefined weld data of one of the number of predefined sections, and
to split each weld 16 into sections according to the identified parts

Examples of predefined sections could include e.g.: a default weld, a default start, a default end, an edge end, an edge start, and a gap weld. The edge start and edge end are a start part, respectively end part of the weld 16 which starts, respectively ends on the edge of the profile and/or sheet material 12. The default start and default end are a start part, respectively end part of the weld 16 which does not start, respectively end on the edge of the profile and/or sheet material 12. The gap weld is a part of the weld 16 which bridges a gap between two to be welded parts. The default weld would be a part of the weld 16 for which no better suited predefined section is available. Using such a collection of predefined sections, the entire weld 16 can be compared and split in sections 18. Of course, the number of predefined sections can be increased or limited. If more predefined sections are present in the system, a more refined control of the welding parameters along the length of a weld is possible, because the splitting up in sections can be done in a more accurate manner. It may, in an embodiment, even be possible to define new predefined sections which may be beneficial for specific welding conditions which are not generally present but which are relevant for a specific facility at which the method is applied and the system is used.

In an embodiment the welding parameters for each section 18 are set in dependence of specific characteristics chosen from the group comprising:
a configuration of the structural steel assembly 10 at the location of the section, in particular the type of the workpieces which bound the respective section, e.g. the type of profile, the type of sheet material, a gap between the workpieces at location of the section 18;
the weld type of the section;
the shape of the weld 16 of the section;
the length 20 of the section 18;
the width of the weld of the section 18;
the location of the section relative to the entire weld, i.e. a start section of the weld, a middle section of the weld or a finish section of the weld;
the local path of the section, e.g. a straight path, a angled path, an arcuate path;
a layer position of the section within a multilayer weld, i.e. the section being a ground layer, an intermediate layer or a top layer of the multilayer weld.

The welding parameters of a specific section 18 are defined and stored in the system. The welding parameters of a specific section 18 may be constant. The parameters may also vary within the section 18. The welding parameters may be substantially constant within an inner part of the section 18 and change at an end of the section 18 so as to have a smooth transition to a subsequent, neighboring section 18. Of course, an individual parameter may be set differently than other parameters. That is, a first parameter may be substantially constant within the section 18, whereas a second parameter may gradually increase within the section 18. Of course, the welding parameters are set once and then stored. The setting is done on the basis of at least one of the above-mentioned characteristics. The setting may in addition to that also be done on the basis of previously set sections wherein the welding parameters are calculated on the basis of interpolation or extrapolation of the welding parameters of the previously set sections.

In an embodiment, the method further comprises providing an automatic welding system comprising a welding robot, providing steel assembly parts, and using the automated process to create the weld 16 including the sections in one go without interrupting the welding process when passing from one section to another within the welding process of the weld 16.

The method may further comprise using the automated process to measure the provided steel assembly parts for establishing actual dimensions along a welding area, such as gap width, gap length etc. Based on the measuring, the method may generate actual weld data for each weld which is corrected with respect to the data received from the CAD-CAM program so as to better reflect the actual dimensions along the welding area in which the weld has to be created. The actual weld data of each weld comprises at least one of:
a weld type;
a position of the respective weld 16 relative to the workpiece or workpieces of the structural steel assembly 10 that bound the weld 16;
a shape of the weld 16;
a length 20 of the weld 16;
a path of the weld 16; and
a width of the weld 16.

In this embodiment, the post-processing of the weld data of each weld is based on the actual weld data so that the splitting of each weld 16 in sections better complies with the actual dimensions of the welding area and that the setting of the individual welding parameters for each section better complies with the actual dimensions of the welding area.

Although CN109128439 teaches to use a visual imaging system, this system is used during the welding and is only used to correct the welding trajectory when the real image diverges from the 3D-CAD-data. There is no teaching in CN′439 to post-process this real image data, wherein the post-processing comprises splitting each weld 16 in sections 18 of which the individual welding parameters are predefined; and to create the weld 16 thereby applying the varying welding parameters along the length of the weld 16 in accordance with the sections 18 into which the weld 16 has been split and the predefined welding parameters associated with these sections 18.

The method is ideally suited for an automatic welding system comprising a welding robot. In such a system, the robot can automatically be provided with the information of the weld 16, the sections 18, and the individual welding parameters for each section 18, in order to weld the weld 16 in one go. The automatic welding system performing this method should be able to change the welding parameters during welding of the one weld 16.

The weld data received from the CAD-CAM program is based on the designed structural steel assembly 10. The actual used assembly parts may, and most likely will differ from the designed, ideal assembly parts. This is due to material tolerances in manufacturing said assembly parts. In order to know what the difference between the designed and actual assembly parts may be, the actual assembly parts may be measured by the automated process. The established actual dimensions along a welding area are used to generate actual weld data for each weld which is corrected with respect to the data received from the CAD-CAM program so as to better reflect the actual dimensions along the welding area in which the weld has to be created. By basing the post-processing on the actual weld data, the splitting of the weld 16 in sections 18 better complies with, and by virtue thereof the welding parameters also better comply with the actual dimensions of the welding area. This will result in a weld 16 which is better tailored to the actual welding area dimensions and thus more accurate and of better quality.

In an embodiment a used welding technique comprises arc welding. The welding parameters may comprise one or more of the group comprising: an amperage, a voltage, a speed, a frequency of weaving, a horizontal distance of weaving, and a vertical distance of weaving.

Other examples of welding techniques which may be applied in the present invention include oxyfuel gas welding, resistance welding, solid-state welding, laser welding and laser-hybrid welding. Each of these techniques have there own associated welding parameters which may be set and are incorporated within the disclosure of this invention.

The invention also relates to an automatic welding system for welding workpieces such as profiles and/or a sheet material 12 which have to be connected by means of one or more welds 16. The welding system comprises a welding robot and a controller assembly which, in operation, operates the welding robot. The controller assembly is provided with a post-processing module configured to receive information from a CAD-CAM program about welds 16 for welding the structural steel assembly 10. As with the method, the information of each single weld 16 comprises data about at least one of:
a type of a workpiece or of workpieces of the structural steel assembly which bound the weld 16;
a weld type;
a position of the respective weld 16 relative to the workpiece or workpieces of the structural steel assembly 10 that bound the weld 16;
a shape of the weld 16;
a length 20 of the weld 16;
a path of the weld 16; and
a width of the weld 16.

The post-processing module is additionally configured to post-process the information received from the CAD-CAM program. The post-processing comprises splitting each weld 16 in sections 18 of which the individual welding parameters are predefined. The automatic welding system is configured to create the weld 16 thereby applying varying welding parameters along the length of the weld 16 in accordance with the sections 18 into which the weld 16 has been split and the predefined welding parameters associated with these sections 18.

The thus described welding system may also perform the method according to the invention.

The effects and advantages of the automatic welding system have been described in the summary section and these effects and advantages are inserted here by reference.

In an embodiment, the automatic welding system further comprises a measuring module for measuring assembly parts of the structural steel assembly 10 along a welding area in which a weld has to be formed. The measuring module establishes actual dimensions, such as gap width, gap length, weld path configuration etc. The controller assembly is configured to, based on the measuring, generate actual weld data for each weld which is actual weld data is corrected with respect to the data received from the CAD-CAM program so as to better reflect the actual dimensions along the welding area in which the weld has to be created. The actual weld data of each weld comprises at least one of:
a weld type;
a position of the respective weld 16 relative to the workpiece or workpieces of the structural steel assembly 10 that bound the weld 16;
a shape of the weld 16;
a length 20 of the weld 16;
a path of the weld 16; and
a width of the weld 16.

In this embodiment, the controller assembly is configured to base the post-processing of the weld data of each weld on the actual weld data so that the splitting of each weld 16 in sections 18 better complies with the actual dimensions of the welding area and that the individual welding parameters for each section 18 better comply with the actual dimensions of the welding area.

An automatic welding system according to this embodiment produces high quality welds which are produced while taking into account the actual dimensions of the welding area in which the weld has to be created. Along the length of the weld, the welding parameters may be changed during the welding of the weld due to the fact that the weld has been split up in various sections during the post-processing. Each section has its own welding parameters. The splitting of the weld to be created in the sections is done by comparing the actual weld data of parts of the weld with the weld data of a number of predefined sections which are stored in the system. Subsequently, parts of the weld 16 are identified parts which have weld data which are similar to the predefined weld data of one of the number of predefined sections. Finally, each weld 16 is split in sections according to the identified parts.

The various embodiments which are described above may be used implemented independently from one another and may be combined with one another in various ways. The reference numbers used in the detailed description and the claims do not limit the description of the embodiments nor do they limit the claims. The reference numbers are solely used to clarify.

### LEGEND

10—structural steel assembly
12—sheet material
14—thicker part of sheet material
16—weld
18—weld section
20—length (of the weld)

1. A method for automatic welding of a structural steel assembly comprising workpieces, including profiles and/or a sheet material which have to be connected by one or more welds, the method comprising using an automated process to:
receive information from a CAD-CAM program about welds for welding the structural steel assembly, wherein the information of each single weld comprises weld data about at least one of:
a type of a workpiece or of workpieces of the structural steel assembly which bound the weld;
a weld type;
a position of the respective weld relative to the workpiece or workpieces of the structural steel assembly that bound the weld;
a shape of the weld;
a length of the weld;
a path of the weld and
a width of the weld; and
using the automated process to:
post-process the weld data of each weld, wherein the post-processing comprises splitting each weld in sections of which the individual welding parameters are predefined; and
create the weld thereby applying the varying welding parameters along the length of the weld in accordance with the sections into which the weld has been split and the predefined welding parameters associated with these sections.

2. The method according to claim 1, wherein one of the sections created during the post-processing is a weld layer, the weld layer being a ground layer, an intermediate layer or a cover layer of a multilayer weld.

3. The method according to claim 1, wherein the post-processing further comprises extending the path of the weld at at least one end thereof, wherein one of the sections created during the post-processing is a start section or a finish section corresponding to an extended part of the path of the weld.

4. The method according to claim 1, wherein the splitting each weld in sections is performed in dependence of specific characteristics chosen from the group comprising:
a configuration of the structural steel assembly at various locations along the length of the weld;
the weld type;
the shape of the weld;
the length of the weld;
the width of the weld; and
the location of a part of the weld relative to the entire weld;
the local path of the weld at a part of the weld that is being considered to become a section; and
a layer position of the section within a multilayer weld, the section being a ground layer, an intermediate layer or a top layer of the multilayer weld.

5. The method according to claim 1, further comprising:
defining and storing a number of predefined sections with predetermined welding parameters, wherein each predefined section is associated with specific characteristics chosen from the group comprising:
a configuration of the structural steel assembly bounding the section;
the weld type of the section;
the shape of the weld of the section;
the length of the weld of the section;
the width of the weld of the section;
the location of the section relative to the entire weld; and
the local path of the section, and
wherein the method further comprises:
comparing, during the post-processing, the weld data of parts of the weld with the predefined weld data of the number of predefined sections;
identifying parts of the weld which have weld data similar to the predefined weld data of one of the number of predefined sections; and
splitting each weld into sections according to the identified parts.

6. The method according to claim 1, wherein the welding parameters for each section are set in dependence of specific characteristics chosen from the group comprising:
a configuration of the structural steel assembly at the location of the section;
the weld type of the section;
the shape of the weld of the section;
the length of the section;
the width of the weld of the section;
the location of the section relative to the entire weld;
the local path of the section;
a layer position of the section within a multilayer weld, the section being a ground layer, an intermediate layer or a top layer of the multilayer weld.

7. The method according to claim 1, wherein the method further comprises:
providing an automatic welding system comprising a welding robot;
providing steel assembly parts; and
using the automated process to create the weld including the sections in one go without interrupting the welding process when passing from one section to another within the welding process of the weld.

8. The method according to claim 7, wherein the method further comprises using the automated process to measure the provided steel assembly parts for establishing actual dimensions along a welding area, and to, based on the measuring, generate actual weld data for each weld which is corrected with respect to the data received from the CAD-CAM program so as to better reflect the actual dimensions along the welding area in which the weld has to be created, wherein the actual weld data of each weld comprises at least one of:
a weld type;
a position of the respective weld relative to the workpiece or workpieces of the structural steel assembly that bound the weld;
a shape of the weld;
a length of the weld;
a path of the weld; and
a width of the weld, and
wherein the post-processing of the weld data of each weld is based on the actual weld data so that the splitting of each weld in sections better complies with the actual dimensions of the welding area and that the individual welding parameters for each section better complies with the actual dimensions of the welding area.

9. The method according to claim 1, wherein a used welding technique comprises arc welding.

10. The method according to claim 9, wherein the welding parameters comprise one or more of the group comprising: an amperage, a voltage, a speed, a frequency of weaving, a horizontal distance of weaving, and a vertical distance of weaving.

11. The method according to claim 1, wherein a used welding technique comprises one of: oxyfuel gas welding, resistance welding, solid-state welding, laser welding and laser-hybrid welding.

12. An automatic welding system for welding workpieces, including profiles and/or a sheet material which have to be connected by means of one or more welds, wherein the welding system comprises:
a welding robot; and
a controller assembly, the controller assembly, in operation, operates the welding robot,
wherein the controller assembly is provided with a post-processing module configured to:
receive information from a CAD-CAM program about welds for welding the structural steel assembly, wherein the information of each single weld comprises data about at least one of:
a type of a workpiece or of workpieces of the structural steel assembly which bound the weld;
a weld type;
a position of the respective weld relative to the workpiece or workpieces of the structural steel assembly that bound the weld;
a shape of the weld;
a length of the weld;
a path of the weld; and
a width of the weld, and
wherein the post-processing module is configured to:
post-process the information received from the CAD-CAM program, wherein the post-processing comprises splitting each weld in sections of which the individual welding parameters are predefined; and
wherein the automatic welding system is configured to create the weld thereby applying varying welding parameters along the length of the weld in accordance with the sections into which the weld has been split and the predefined welding parameters associated with these sections.

13. The welding system according to claim 12, further comprising a measuring module for measuring assembly parts of the structural steel assembly along a welding area in which a weld has to be formed, wherein the measuring module establishes actual dimensions, wherein the controller assembly is configured to, based on the measuring, generate actual weld data for each weld which is actual weld data is corrected with respect to the data received from the CAD-CAM program so as to better reflect the actual dimensions along the welding area in which the weld has to be created, wherein the actual weld data of each weld comprises at least one of:
a weld type;
a position of the respective weld relative to the workpiece or workpieces of the structural steel assembly that bound the weld;
a shape of the weld;
a length of the weld;
a path of the weld; and
a width of the weld, and
wherein the controller assembly is configured to base the post-processing of the weld data of each weld on the actual weld data so that the splitting of each weld in sections better complies with the actual dimensions of the welding area and that the individual welding parameters for each section better comply with the actual dimensions of the welding area.

14. The method according to claim 4, wherein the configuration of the structural steel assembly at the location of the section is defined by at least one of:
the type of workpieces which bound the respective section including at least one of, the type of profile, and the type of sheet material; and
a gap between the workpieces at location of the section.

15. The method according to claim 5, wherein the configuration of the structural steel assembly at the location of the section is defined by at least one of:
the type of workpieces which bound the respective section including at least one of, the type of profile, and the type of sheet material; and
a gap between the workpieces at location of the section.

16. The method according to claim 6, wherein the configuration of the structural steel assembly at the location of the section is defined by at least one of:
the type of workpieces which bound the respective section including at least one of, the type of profile, and the type of sheet material; and
a gap between the workpieces at location of the section.

17. The method according to claim 2, wherein the post-processing further comprises extending the path of the weld at least one end thereof, wherein one of the sections created during the post-processing is a start section or a finish section corresponding to an extended part of the path of the weld.

18. The method according to claim 2, wherein the splitting each weld in sections is performed in dependence of specific characteristics chosen from the group comprising:
a configuration of the structural steel assembly at various locations along the length of the weld;
the weld type;
the shape of the weld;
the length of the weld;
the width of the weld; and
the location of a part of the weld relative to the entire weld;
the local path of the weld at a part of the weld that is being considered to become a section; and
a layer position of the section within a multilayer weld, the section being a ground layer, an intermediate layer or a top layer of the multilayer weld.

19. The method according to claim 3, wherein the splitting each weld in sections is performed in dependence of specific characteristics chosen from the group comprising:
a configuration of the structural steel assembly at various locations along the length of the weld;
the weld type;
the shape of the weld;
the length of the weld;
the width of the weld; and
the location of a part of the weld relative to the entire weld;
the local path of the weld at a part of the weld that is being considered to become a section; and
a layer position of the section within a multilayer weld, the section being a ground layer, an intermediate layer or a top layer of the multilayer weld.

20. The method according to claim 2, further comprising:
defining and storing a number of predefined sections with predetermined welding parameters wherein each predefined section is associated with specific characteristics chosen from the group comprising:
a configuration of the structural steel assembly bounding the section;
the weld type of the section;
the shape of the weld of the section;
the length of the weld of the section; and
the width of the weld of the section;
the location of the section relative to the entire weld; and
the local path of the section, and
wherein the method further comprises:
comparing, during the post-processing, the weld data of parts of the weld with the predefined weld data of the number of predefined sections;
identifying parts of the weld which have weld data similar to the predefined weld data of one of the number of predefined sections; and
splitting each weld into sections according to the identified parts.
